(19) United States
(12) Patent Application Publication
(10) Pub. No.: US 2023/0173725 A1
(43) Pub. Date: Jun. 8, 2023

(54) CONTROLLER AND PROGRAM FOR INJECTION MOLDING MACHINE

(71) Applicant: FANUC CORPORATION, Minamitsuru-gun, Yamanashi (JP)

(72) Inventor: Kensuke NAMIKI, Yamanashi (JP)

(21) Appl. No.: 17/925,469

(22) PCT Filed: Jun. 4, 2021
(86) PCT No.: PCT/JP2021/021410

§ 371 Date: Nov. 15, 2022

(30) Foreign Application Priority Data
Jun. 5, 2020 (JP) 2020-098815

(51) Int. Cl. B29C 45/62; B29C 45/78; B29C 45/80

(52) U.S. Cl. CPC B29C 45/62; B29C 45/78; B29C 45/80

(57) ABSTRACT

A controller includes an operation information acquisition unit that acquires operation information, a characteristic information acquisition unit that acquires characteristic information of heat dissipation characteristics of a heater, a surface temperature acquisition unit that acquires the surface temperature of the heater, and a results information acquisition unit that acquires results of a transition in the ratio of the surface temperature and a set temperature with respect to a transition in the heater output as results information. The controller also includes an estimation unit that uses the operation and results information, and the acquired surface temperature to estimate the surface temperature of the heater, and an energy quantity calculation unit that uses the estimated surface temperature and characteristic information to calculate the heat quantity dissipation from the surface of the heater and calculates heat transfer energy quantity transmitted from the heater to a resin and the shear energy quantity.

### TECHNICAL FIELD

The present disclosure relates to controller and program for an injection molding machine.

### BACKGROUND ART

Typically, an injection molding machine has been known, in which pellets (resin) injected into a hopper are melted in a barrel and are injected into a mold. Heaters are arranged at the outer periphery of the barrel of the injection molding machine. The heaters heat the barrel, thereby melting the pellets.

It is useful for monitoring a molding state and optimizing condition settings to monitor a relationship between the heat quantity provided to the injection molding machine and a temperature change. Thus, for example, an injection molding machine has been proposed, in which a correspondence between the heat quantity generated only by a heater and the temperature of a heated barrel is measured in advance and a difference between a barrel temperature in actual molding and the barrel temperature in the measured correspondence is calculated as a temperature change due to shear heating (see, e.g., Patent Document 1).
Patent Document 1: Japanese Unexamined Patent Application, Publication No. 2001-225372

### DISCLOSURE OF THE INVENTION

### Problems to be Solved by the Invention

In the injection molding machine, the pellets injected through a hopper port are melted by heat transfer from the heater and shear heating by rotation of a screw. In generally, “heat transfer” is characterized by a relatively low heat supply capacity with relatively low variability. On the other hand, “shear” is characterized by a relatively high heat supply capacity with relatively high variability. It is considered to be favorable to allocate the ratios of “heat transfer” and “shear heating” optimally according to a demand for a molded product. On the other hand, the level of difficulty in proper setting of molding conditions has increased due to an increase in the number of types of pellets and a complicated shape of the molded product. For these reasons, appropriateness of the molding conditions is often determined based on the experience and intuition of a skilled technician. In Patent Document 1, only the temperature change due to shear heating is calculated. For this reason, in Patent Document 1, it is difficult to grasp whether a temperature change upon a condition change is due to the condition change or not. Regarding the condition change, it is considered to be favorravel to obtain a cause of the temperature change quantitatively.

### Means for Solving the Problems

(1) The present disclosure relates to a controller for an injection molding machine including a barrel, a heater arranged around the barrel, and a screw arranged inside the barrel, the controller being configured to calculate an energy quantity transferred from the heater to resin at a predetermined time. The controller includes an operation information acquisition unit that acquires operation information including the heater output of the heater, a set temperature for the heater, and the rotation number of the screw in a predetermined period immediately before the predetermined time, a characteristic information acquisition unit that acquires characteristic information regarding heat dissipation characteristics of the heater, a surface temperature acquisition unit that acquires the surface temperature of the heater in the predetermined period included in the acquired operation information, a results information acquisition unit that acquires, as results information, results of a transition in the ratio of the surface temperature of the heater to the set temperature for the heater in association with a transition in the heater output of the heater, an estimation unit that estimates the surface temperature of the heater at the predetermined time based on the operation information, the results information, and the acquired surface temperature, and an energy quantity calculation unit that calculates, based on the estimated surface temperature, the characteristic information, and the operation information, a heat dissipation quantity from a surface of the heater to the atmosphere and calculates at least a heat transfer energy quantity from the heater to the resin and a shear energy quantity from the screw.

(2) The present disclosure relates to a program causing a computer to operate as a controller for an injection molding machine including a barrel, a heater arranged around the barrel, and a screw arranged inside the barrel, the controller being configured to calculate an energy quantity transferred from the heater to resin at a predetermined time. The program causes the computer to function as an operation information acquisition unit that acquires operation information including the heater output of the heater, a set temperature for the heater, and the rotation number of the screw in a predetermined period immediately before the predetermined time, a characteristic information acquisition unit that acquires characteristic information regarding heat dissipation characteristics of the heater, a surface temperature acquisition unit that acquires the surface temperature of the heater in the predetermined period included in the acquired operation information, a results information acquisition unit that acquires, as results information, results of a transition in the ratio of the surface temperature of the heater to the set temperature for the heater in association with a transition in the heater output of the heater, an estimation unit that estimates the surface temperature of the heater at the predetermined time based on the operation information, the results information, and the acquired surface temperature, and an energy quantity calculation unit that calculates, based on the estimated surface temperature, the characteristic information, and the operation information, a heat dissipation quantity from a surface of the heater to the atmosphere and calculates at least a heat transfer energy quantity from the heater to the resin and a shear energy quantity from the screw.

### Effects of the Invention

According to the present disclosure, controller and program for an injection molding machine can be provided, which can quantitatively obtain a cause of a temperature change.

### BRIEF DESCRIPTION OF THE DRAWINGS

FIG. 1 is a schematic view showing an injection molding machine including a controller according to one embodiment of the present disclosure;

FIG. 2 is a table showing one example of results information learned by the controller of one embodiment;

FIG. 3 is a schematic view showing a relationship among a heat generation quantity and a heat dissipation quantity from heaters and a screw of the injection molding machine of one embodiment and the heat quantity provided to pellets;

FIG. 4 is a block diagram showing the configuration of the controller of one embodiment;

FIG. 5 is a schematic view showing one example of operation information of the controller of one embodiment;

FIG. 6 is a schematic view showing one example of results information of the controller of one embodiment;

FIG. 7 is a view showing a screen displayed on a display unit of the controller of one embodiment;

FIG. 8 is a flowchart showing the flow of operation of the controller of one embodiment;

FIG. 9 is a view showing a screen displayed on a display unit of a controller of a variation;

FIG. 10 is a view showing a screen displayed on a display unit of a controller of another variation;

FIG. 11 is a view showing a screen displayed on a display unit of a controller of yet another variation; and

FIG. 12 is a view showing a screen displayed on a display unit of a controller of yet another variation.

### PREFERRED MODE FOR CARRYING OUT THE INVENTION

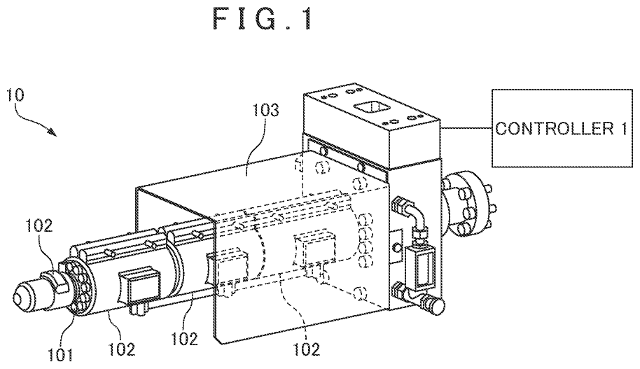

Hereinafter, controller 1 and program for an injection molding machine 10 according to one embodiment of the present disclosure will be described with reference to FIGS. 1 to 8. First, the injection molding machine 10 controlled by the present embodiment will be described. The injection molding machine 10 is a device that performs molding in such a manner that pellets are melted and injected into a mold (not shown). The injection molding machine 10 includes, for example, a barrel 101, heaters 102, and a safety cover 103, as shown in FIG. 1.

The barrel 101 is, for example, a tubular body. One end portion of the barrel 101 in an axial direction thereof is narrowed toward an end. The barrel 101 has, along the axial direction, a screw (not shown) inside. The screw stirs the melted pellets while moving the melted pellets to one end side of the barrel 101.

The heaters 102 are arranged around the barrel 101. The plurality of heaters 102 is, for example, arranged along the axial direction of the barrel 101. In the present embodiment, three heaters 102 are arranged along the axial direction so as to cover the outer periphery of the barrel 101. The heaters 102 heat, for example, the barrel 101 to 200 degrees Celsius or higher.

The safety cover 103 is a recessed body arranged around the heaters 102. The safety cover 103 is arranged for avoiding contact with the heaters 102 at a relatively-high temperature.

According to the above-described injection molding machine 10, the pellets are melted inside the barrel 101 heated to 200 degrees Celsius or higher by the heaters 102. The screw injects the melted pellets into the mold from one end of the barrel 101. In this manner, the injection molding machine 10 molds, for example, a plastic product.

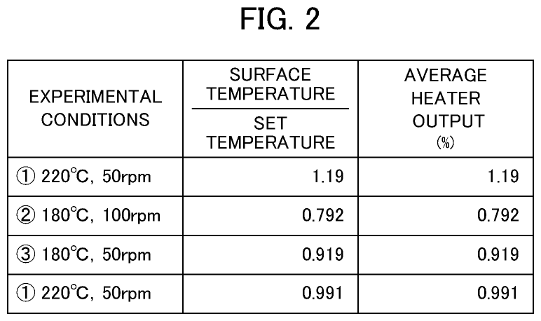

Since the safety cover 103 is arranged around the heaters 102, the surface temperature of the heater 102 cannot be easily directly measured from the outside. It has been found that an actual surface temperature of the heater 102, a set temperature for the heater 102, and the heater output of the heater 102 correlate with each other. Specifically, it has been found that the average heater output of the heaters 102 and the ratio of the surface temperature of the heater 102 to the set temperature for the heater 102 correlate with each other. For example, as shown in FIG. 2, the set temperature for the heater 102 and the rotation number of the screw were set to (1) 220 degrees Celsius and 50 rpm, (2) 180 degrees Celsius and 100 rpm, and (3) 180 degrees Celsius and 50 rpm. As a result, vales of Surface Temperature/Set Temperature were 1.19, 0.792, and 0.919, and values of the average heater output were 46.6%, 6.62%, and 14.5%. As a result, the coefficient of correlation between Surface Temperature/Set Temperature and the heater output was 0.991. Thus, it has been found that there is a high correlation between Surface Temperature/Set Temperature and the heater output. Note that in an embodiment below, the heater output will be described as a command value for instructing an operation amount of the heater 102 from a controller (not shown) that controls the heater 102. The controller sets, as one example, the command value based on a detection value at a temperature control point.

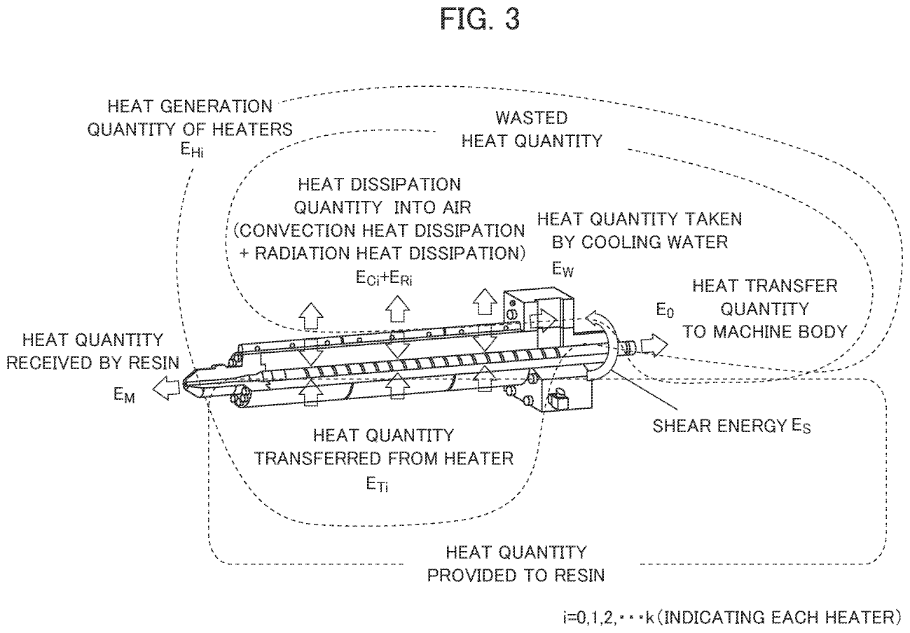

A heat generation quantity E_{Hi} of the heater 102 may be indicated by a convection heat dissipation quantity E_{Ci}, a radiation heat dissipation quantity E_{Ri} a heat quantity E_{M} taken by cooling water, a heat transfer quantity E₀ to a machine body (a hopper side), a heat quantity E_{M} received by resin, and a shear energy E_{S}, as shown in FIG. 3. Here, i (i=1, 2, . . . , k) is a natural number, and indicates a number for identifying k heaters 102. For example, the heat dissipation quantity to the atmosphere (the convection heat dissipation+the radiation heat dissipation) may be represented by Equation 1 below.

$${\sum }_{i - 0}^{k} ( {E}_{Ci} + {E}_{Ri} ) {\sum }_{t - 0}^{k} ( {E}_{Hi} ) - {E}_{W} - {E}_{0} + {E}_{S} - {E}_{M} \qquad [ Equation 1 ]$$

The controller 1 for the injection molding machine 10 according to the embodiment below estimates, using the above-described correlation, the surface temperature of the heater 102 from the outside. With this configuration, the controller 1 for the injection molding machine 10 according to the embodiment below more accurately estimates the surface temperature of the heater 102 as compared to estimation of the surface temperature of the heater 102 according to an equation from the temperature control points, detection points of additional sensors, etc. The controller 1 for the injection molding machine 10 according to the embodiment below calculates the quantity of energy transferred from the heater 102 to the resin. The controller 1 for the injection molding machine 10 calculates, for example, a heat transfer energy quantity from the heater 102 and a shear energy quantity from the screw. The controller 1 for the injection molding machine according to the embodiment below calculates the ratios of the heat transfer energy quantity and the shear energy quantity. Accordingly, the controller 1 for the injection molding machine according to the embodiment below quantitatively obtains an energy change under changed operation conditions. Note that in the embodiment below, “in operation” indicates a moment in which the injection molding machine 10 is actually operating. Moreover, in the embodiment below, a “predetermined time” indicates a time targeted for estimation of the surface temperature of the heater 102.

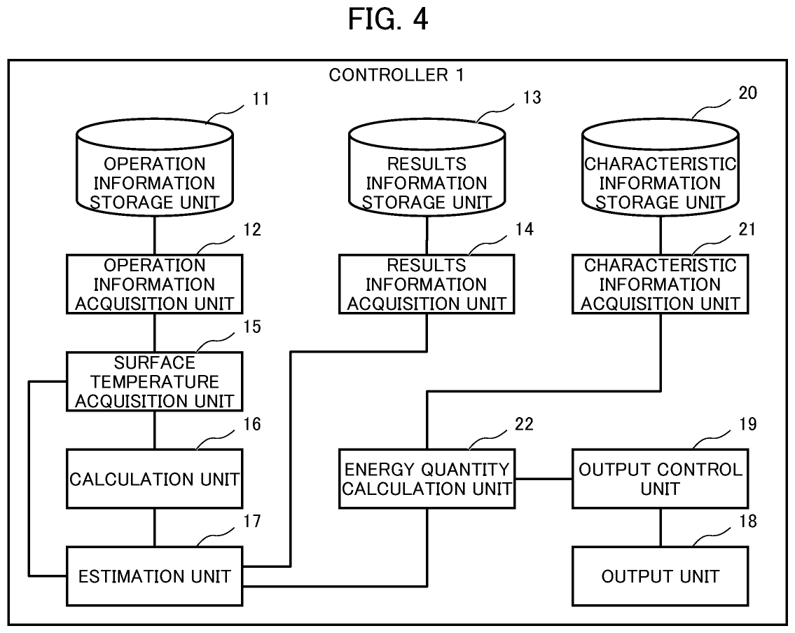

Next, the controller 1 for the injection molding machine 10 according to one embodiment of the present disclosure will be described with reference to FIGS. 1 to 8. The controller 1 is a device that controls the injection molding machine 10. Specifically, the controller 1 is a device that controls conditions for molding by the injection molding machine 10. The controller 1 is, for example, connected to the injection molding machine 10 as shown in FIG. 1. The controller 1 controls specified molding conditions such as a speed and a pressure in injection molding, the temperature of the barrel 101, a mold temperature, and the amount of melted pellets to be injected. As shown in FIG. 4, the controller 1 includes an operation information storage unit 11, an operation information acquisition unit 12, a characteristic information storage unit 20, a characteristic information acquisition unit 21, a results information storage unit 13, a results information acquisition unit 14, a surface temperature acquisition unit 15, a calculation unit 16, an estimation unit 17, an energy quantity calculation unit 22, an output unit 18, and an output control unit 19.

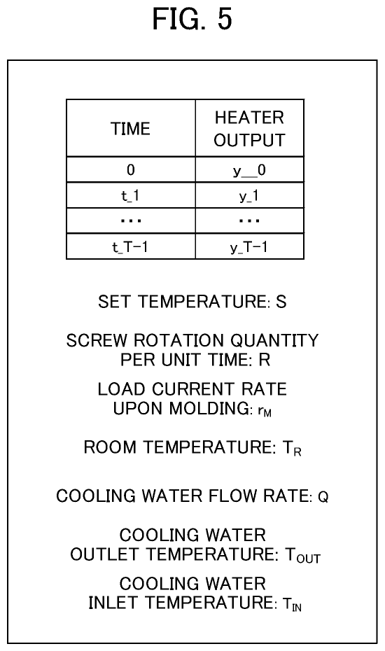

The operation information storage unit 11 is, for example, a storage medium such as a hard disk. The operation information storage unit 11 stores operation information regarding the set temperature for the heater 102 of the injection molding machine 10 and the heater output of the heater 102 in operation. Moreover, the operation information storage unit 11 stores, as the operation information, the contents of instructions regarding operation of the injection molding machine 10, for example. For example, as shown in FIG. 5, the operation information storage unit 11 stores heater outputs y_0, y_1, . . . , y_T−1 in every sampling cycle t_1(s) until a point t_T−1 immediately before the predetermined time, assuming that an operation start point is 0 and the predetermined time is T. Moreover, the operation information storage unit 11 stores S (° C.) as the set temperature. Further, the operation information storage unit 11 stores the above-described molding conditions as the operation information. For example, the operation information storage unit 11 stores, as the operation information, a screw rotation quantity per unit time, a load current rate upon molding, a room temperature, a cooling water flow rate, a cooling water outlet temperature, and a cooling water inlet temperature.

The operation information acquisition unit 12 is, for example, implemented by operation of a CPU. The operation information acquisition unit 12 acquires, as the operation information, the heater output of the heater 102 and the set temperature for the heater 102 in a predetermined period immediately before the predetermined time. In the present embodiment, the operation information acquisition unit 12 acquires the operation information from the operation information storage unit 11. For example, the operation information acquisition unit 12 acquires, as the operation information, the heater output of the heater 102 and the set temperature for the heater 102 in a period from the start of operation of the injection molding machine 10 to a point immediately before the predetermined time. The operation information acquisition unit 12 acquires, for example, the heater output in a preset sampling cycle until a point immediately before the predetermined time. Moreover, the operation information acquisition unit 12 acquires, as the operation information, the screw rotation quantity which is a rotation number set for the screw, the load current rate, the room temperature, the flow rate, the cooling water outlet temperature, and the cooling water inlet temperature.

The characteristic information storage unit 20 is, for example, a storage medium such as a hard disk. The characteristic information storage unit 20 stores characteristic information regarding heat dissipation characteristics of the heater 102. The characteristic information storage unit 20 stores, as the characteristic information, specific information to the heater 102. For example, the characteristic information storage unit 20 stores, as the characteristic information, a motor torque including a machine efficiency and a reduction ratio, a load current rate upon idling, a heater capacity, the surface area of the heater 102, an emissivity, a Stefan-Boltzmann constant, a water density, and a ratio of water.

The characteristic information acquisition unit 21 is, for example, implemented by operation of the CPU. The characteristic information acquisition unit 21 acquires the characteristic information regarding the heat dissipation characteristics of the heater 102.

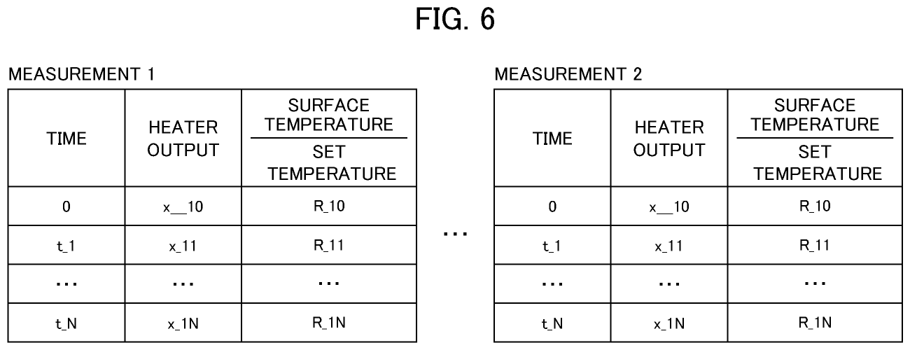

The results information storage unit 13 is, for example, a storage medium such as a hard disk. The results information storage unit 13 stores, as results information, results of a transition in the ratio of the surface temperature of the heater 102 to the set temperature for the heater 102 in association with a transition in the heater output of the heater 102. For example, by taking the transition in the heater output of the heater 102 measured in advance as input data, the results information storage unit 13 stores, as the results information, the transition, which is measured at the same time as the heater output, in the ratio (Surface Temperature/Set Temperature) of the surface temperature of the heater 102 to the set temperature for the heater 102. The results information storage unit 13 stores the results information obtained in advance by learning the teaching data with the heater output as input. Using temperature sensors (not shown) provided in advance so as to contact the surface of the heater 102, the results information storage unit 13 may store, for example, the results information obtained by learning of the relationship between the heater output and the surface temperature as shown in FIG. 2. The results information storage unit 13 stores, for example, a plurality of results as the results information. For example, as shown in FIG. 6, the results information storage unit 13 stores, for each measured results, the results information including a heater output value of x_MN and a Surface Temperature/Set Temperature value of R_MN, assuming that a measurement number is M (M is a natural number), a measurement start time (an operation start time) is 0, and the acquisition time of the heater output is tM_N (N is a natural number).

The results information acquisition unit 14 is, for example, implemented by operation of the CPU. The results information acquisition unit 14 acquires the results information from the results information storage unit 13. For example, the results information acquisition unit 14 acquires, as the results information, the results of the transition in the ratio of the surface temperature of the heater 102 to the set temperature for the heater 102 in association with the transition in the heater output of the heater 102. Specifically, the results information acquisition unit 14 acquires, for each previous heater output, the ratio (Surface Temperature/Set Temperature) of a previous surface temperature to a previous set temperature as the results information.

The surface temperature acquisition unit 15 is, for example, implemented by operation of the CPU. The surface temperature acquisition unit 15 acquires the surface temperature of the heater 102 in a period included in the acquired operation information. The surface temperature acquisition unit 15 acquires, for example, a surface temperature estimated by the later-described estimation unit 17 in a period included in the acquired operation information. Alternatively, the surface temperature acquisition unit 15 acquires, instead of the estimated surface temperature, a surface temperature actually measured or provided from the outside. The surface temperature acquisition unit 15 acquires, for example, a surface temperature TP A (° C.) (A=1, 2, . . . , t−1) in every sampling cycle t_1.

The calculation unit 16 is, for example, implemented by operation of the CPU. Based on the acquired operation information and the acquired surface temperature, the calculation unit 16 calculates the transition in the ratio of the surface temperature to the set temperature in association with the transition in the heater output included in the operation information. The calculation unit 16 calculates, for example, the value of Surface Temperature/Set Temperature for each heater output included in the operation information. In the present embodiment, the calculation unit 16 calculates (TP A/S) (A=1, 2, . . . , t−1) in every sampling cycle t_1.

The estimation unit 17 is, for example, implemented by operation of the CPU. Based on the operation information, the results information, and the acquired surface temperature, the estimation unit 17 estimates the surface temperature of the heater 102 at the predetermined time. Specifically, the estimation unit 17 estimates the surface temperature at the predetermined time by means of the operation information and results similar to or coincident with the calculated ratio transition among the results included in the results information. The estimation unit 17 estimates the surface temperature at the predetermined time from the ratio, which is indicated by the results similar to or coincident with the transition, of the surface temperature to the set temperature at a time corresponding to the predetermined time. For example, the estimation unit 17 specifies, from the results information, results similar to or coincident with the transition in the heater output and the transition in the ratio of the surface temperature to the set temperature in the operation information indicating a predetermined period until a point immediately before the predetermined time. The estimation unit 17 acquires the ratio of the surface temperature to the set temperature at a subsequent time (corresponding to the predetermined time) after a lapse of the period included in the specified similar or coincident results. Then, the estimation unit 17 multiplies the acquired ratio by the set temperature included in the operation information, thereby estimating the surface temperature at the predetermined time.

The energy quantity calculation unit 22 is, for example, implemented by operation of the CPU. The energy quantity calculation unit 22 calculates the heat dissipation quantity from the surface of the heater 102 to the atmosphere based on the estimated surface temperature and the characteristic information. That is, the energy quantity calculation unit 22 calculates, as the heat dissipation quantity to the atmosphere, the sum of the convection heat dissipation and the radiation heat dissipation of the k heaters 102. The energy quantity calculation unit 22 calculates a heat dissipation quantity E_{Ai} according to Equation 2 below, assuming that the heat dissipation quantity (J) from the heater 102 to the atmosphere is E_{Ai}, the convection heat dissipation quantity (J) is E_{Ci}, the radiation heat dissipation quantity (J) is E_{Ri}, the surface temperature (K) of the heater 102 is T_{H}, the room temperature (K) is T_{R}, the surface area (m²) of the heater 102 is Aᵢ, a heat transfer coefficient (W/m²K) is h, the emissivity is s, the Stefan-Boltzmann constant (W/m²K⁴) is σ, and the number for identifying the k heaters 102 is i=1, 2, . . . , k. [Equation 2]

E_{Ai}=E_{Ci}+E_{Ri}

E_{Ci}=Aᵢ×∫ₜ_{₀}^{t}^{₁}{(T_{H}−T_{R})×h}dt

E_{Ci}=Aᵢ×∫ₜ_{₀}^{t}^{₁}{(T_{H}⁴−T_{R}⁴)×ε×σ}dt

Note that the energy quantity calculation unit 22 may calculate E_{Ai} by using, as the heat transfer coefficient h, the function of a temperature difference between the surface temperature of the heater 102 and an atmosphere temperature.

Moreover, the energy quantity calculation unit 22 calculates at least the heat transfer energy quantity from the heater 102 to the resin (the pellets) and the shear energy quantity from the screw. The energy quantity calculation unit 22 calculates Equation 3 below, assuming that the shear energy (J) from the screw is E_{S}, the motor torque (Nm) including the machine efficiency and the reduction ratio is T, the screw rotation quantity (rad/s) per unit time is R, the load current rate upon molding is r_{M}, and the load current rate upon idling is r_{M0}. In this manner, the energy quantity calculation unit 22 obtains the shear energy E_{S}, thereby calculating the workload of a motor for rotating the screw. The motor torque may be a rated torque or a maximum torque. The load current rate is a command value from the controller that controls the motor for rotating the screw, and indicates the ratio of a load torque with respect to the motor torque.

E_{S}=T×R×∫ₜ_{₀}^{t}^{₁}(r_{M}−r_{M0})×dt [Equation 3]

The energy quantity calculation unit 22 calculates Equation 4 below, assuming that the heat transfer energy quantity (J) is E_{T}, the heat generation quantity (J) of the heater 102 is E_{Hi} the convection heat dissipation quantity (J) from the heaters 102 and part of the barrel 101 is E_{Ci}′, the radiation heat dissipation quantity (J) from the heaters 102 and part of the barrel 101 is E_{Ri}′, the heat quantity (J) taken by cooling water is E_{W}, the heat transfer quantity (J) to the hopper side is E₀, the capacity (W) of the heater 102 is Wᵢ, the heater output is rᵢ, the convection heat dissipation quantity (J) from a region without the heaters 102 is E_{CNi}, the radiation heat dissipation quantity (J) from the region without the heaters 102 is E_{RNi}, the water density (g/cm³) is p, the specific heat of water (J/gK) is C_{W}, the water flow rate (cm³/s) is Q, the cooling water outlet temperature (K) is T_{OUT}, and the cooling water inlet temperature (K) is T_{IN}. In this manner, the energy quantity calculation unit 22 calculates the heat transfer energy quantity ET.

$${E}_{T} = {\sum }_{i} ( {E}_{Hi} - {E}_{Ci}^{′} - {E}_{Ri}^{′} ) - {E}_{W} - {E}_{0} \qquad [ Equation 4 ]$$

$${E}_{Hi} = {\int }_{{t}_{0}}^{{t}_{1}} ( {W}_{i} \times {r}_{i} ) dt$$

$${E}_{Ci}^{′} = {A}_{i} \times {\int }_{{t}_{0}}^{{t}_{1}} \{ ( {T}_{H} - {T}_{R} ) \times h \} dt + {E}_{CNi}$$

$${E}_{Ri}^{′} = {A}_{i} \times {\int }_{{t}_{0}}^{{t}_{1}} \{ ( {T}_{H}^{4} - {T}_{R}^{4} ) \times ε \times σ \} dt + {E}_{RNi}$$

$${E}_{W} = p \times {C}_{W} \times {\int }_{{t}_{0}}^{{t}_{1}} \{ Q \times ( {T}_{OUT} - {T}_{IN} ) \} dt$$

Moreover, the energy quantity calculation unit 22 calculates the ratios of the heat transfer energy quantity from the heater 102 to the resin (the pellets) and the shear energy quantity from the screw. The energy quantity calculation unit 22 calculates a ratio between the heat transfer energy quantity and the shear energy quantity, thereby calculating the ratios.

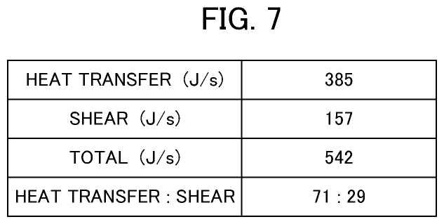

The output unit 18 is, for example, a display unit such as a display. The output unit 18 outputs the calculated heat dissipation quantity to the outside. For example, as shown in FIG. 7, the output unit 18 displays at least one of the heat transfer energy quantity, the shear energy quantity, or the ratios.

The output control unit 19 is, for example, implemented by operation of the CPU. The output control unit 19 causes the output unit 18 to output the calculated heat dissipation quantity. The output control unit 19 causes the output unit 18 to output at least one of the calculated heat transfer energy quantity, the shear energy quantity, or the ratios.

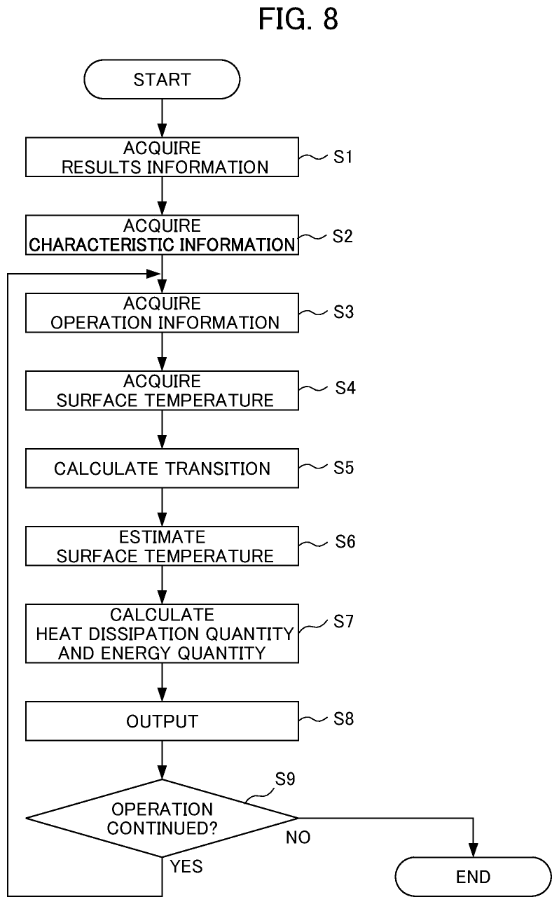

Next, the flow of processing by the controller 1 will be described with reference to FIG. 8. First, the results information acquisition unit 14 acquires the results information (Step S1). The results information acquisition unit 14 acquires, for example, plural pieces of results information from the results information storage unit 13.

Subsequently, the characteristic information acquisition unit 21 acquires the characteristic information (Step S2). The characteristic information acquisition unit 21 acquires, for example, the characteristic information stored in advance in the characteristic information storage unit 20.

Subsequently, the operation information acquisition unit 12 acquires the operation information (Step S3). The operation information acquisition unit 12 acquires, for example, the operation information stored in advance in the operation information storage unit 11.

Subsequently, the surface temperature acquisition unit 15 acquires the surface temperature corresponding to the operation information (Step S4).

Subsequently, the calculation unit 16 calculates, based on the acquired operation information and the acquired surface temperature, the transition in the ratio of the surface temperature to the set temperature in association with the transition in the heater output included in the operation information (Step S5). Subsequently, the estimation unit 17 estimates the surface temperature of the heater 102 from the operation information, the surface temperature, and the results information (Step S6).

In Step S7, the energy quantity calculation unit 22 calculates the heat dissipation quantity based on the estimated surface temperature of the heater 102 and the characteristic information. The energy quantity calculation unit 22 calculates, for example, the heat dissipation quantity for each heater 102. Moreover, the energy quantity calculation unit 22 calculates the heat transfer energy quantity, the shear energy quantity, and the ratios of the heat transfer energy quantity and the shear energy quantity.

In Step S8, the output control unit 19 outputs, to the output unit 18, the calculated heat dissipation quantity, the heat transfer energy quantity, the shear energy quantity, the ratio of the heat transfer energy quantity and the shear energy quantity. The output unit 18 displays, for example, the calculated heat dissipation quantity, the heat transfer energy quantity, the shear energy quantity, the ratio of the heat transfer energy quantity and the shear energy quantity.

Subsequently, it is determined whether calculation of the heat dissipation quantity is to be repeated or not (Step S9). If the calculation is to be repeated (Step S9: YES), the processing returns to Step S3. On the other hand, if the calculation ends (Step S9: NO), the processing flow ends.

Next, the program of the present embodiment will be described. Each configuration included in the controller 1 for the injection molding machine 10 may be implemented by hardware, software, or a combination thereof. Implementation by the software as described herein means implementation by reading and execution of a program by a computer.

The program can be stored using various types of non-transitory computer readable medium and be supplied to the computer. The non-transitory computer readable medium include various types of tangible storage medium. Examples of the non-transitory computer readable medium include magnetic storage medium (e.g., a flexible disk, a magnetic tape, and a hard disk drive), magnetic optical storage medium (e.g., a magnetic optical disk), a CD-read only memory (CD-ROM), a CD-R, a CD-R/W, and semiconductor memories (e.g., a mask ROM, a programmable ROM (PROM), an erasable PROM (EPROM), a flash ROM, and a random access memory (RAM)). The program may be supplied to the computer via various types of transitory computer readable medium. Examples of the transitory computer readable medium include an electric signal, an optical signal, and an electromagnetic wave. The transitory computer readable medium can supply the program to the computer via a wired communication path such as an electric wire or an optical fiber or a wireless communication path.

According to the controller 1 and program for the injection molding machine according to one embodiment as described above, the following advantageous effects are produced.

(1) The controller 1 for the injection molding machine 10 including the barrel 101, the heaters 102 arranged around the barrel 101, and the screw arranged inside the barrel 101 for calculating the energy quantity transferred from the heater to the resin at a predetermined time includes the operation information acquisition unit 12 that acquires the operation information including the heater output of the heater 102, the set temperature for the heater 102, and the rotation number of the screw in the predetermined period immediately before the predetermined time, the characteristic information acquisition unit 21 that acquires the characteristic information regarding the heat dissipation characteristics of the heater 102, the surface temperature acquisition unit 15 that acquires the surface temperature of the heater 102 in the predetermined period included in the acquired operation information, the results information acquisition unit 14 that acquires, as the results information, the results of the transition in the ratio of the surface temperature of the heater 102 to the set temperature for the heater 102 in association with the transition in the heater output of the heater 102, the estimation unit 17 that estimates the surface temperature of the heater 102 at the predetermined time based on the operation information, the results information, and the acquired surface temperature, and the energy quantity calculation unit 22 that calculates, based on the estimated surface temperature, the characteristic information, and the operation information, the heat dissipation quantity from the surface of the heater 102 to the atmosphere and calculates at least the heat transfer energy quantity from the heater 102 to the resin and the shear energy quantity from the screw. The program causing the computer to operate as the controller 1 for the injection molding machine 10 including the barrel 101, the heaters 102 arranged around the barrel 101, and the screw arranged inside the barrel 101 for calculating the energy quantity transferred from the heater to the resin at the predetermined time includes instructions that cause the computer to function as the operation information acquisition unit 12 that acquires the operation information including the heater output of the heater 102, the set temperature for the heater 102, and the rotation number of the screw in the predetermined period immediately before the predetermined time, the characteristic information acquisition unit 21 that acquires the characteristic information regarding the heat dissipation characteristics of the heater 102, the surface temperature acquisition unit 15 that acquires the surface temperature of the heater 102 in the predetermined period included in the acquired operation information, the results information acquisition unit 14 that acquires, as the results information, the results of the transition in the ratio of the surface temperature of the heater 102 to the set temperature for the heater 102 in association with the transition in the heater output of the heater 102, the estimation unit 17 that estimates the surface temperature of the heater 102 at the predetermined time based on the operation information, the results information, and the acquired surface temperature, and the energy quantity calculation unit 22 that calculates, based on the estimated surface temperature, the characteristic information, and the operation information, the heat dissipation quantity from the surface of the heater 102 to the atmosphere and calculates at least the heat transfer energy quantity from the heater 102 to the resin and the shear energy quantity from the screw. With this configuration, the accuracy of the estimated surface temperature of the heater 102 can be further improved regardless of the outer shape (asperities) of the barrel 101. Physical sensors, etc. do not need to be placed on the surface of the heater 102, and therefore, cost can be reduced. The heat dissipation quantity of each heater 102 can be calculated based on the estimated surface temperature. Thus, the heat dissipation quantity from the surface of the heater 102 to the air can be more accurately calculated. As a result, operation or a molding condition for minimizing the heat dissipation quantity is set so that the life of the heater 102 can be extended and power for driving the injection molding machine 10 can be reduced.
(2) The energy quantity calculation unit 22 calculates the ratios of the heat transfer energy quantity from the heater 102 to the resin and the shear energy quantity from the screw. With this configuration, a cause of a temperature change can be more quantitatively obtained.
(3) The controller 1 for the injection molding machine 10 further includes the calculation unit 16 that calculates, based on the acquired operation information and the acquired surface temperature, the transition in the ratio of the surface temperature to the set temperature in association with the transition in the heater output included in the operation information. The estimation unit 17 estimates the surface temperature at the predetermined time by means of the operation information and the results similar to or coincident with the calculated ratio transition among the results included in the results information. With this configuration, the heater output and the set temperature are acquired so that the surface temperature can be easily estimated.
(4) The surface temperature acquisition unit 15 acquires the surface temperature of the heater 102 in the form of the ratio of the surface temperature of the heater 102 to the set temperature for the heater 102, and the estimation unit 17 estimates the surface temperature at the predetermined time by means of the operation information and the results similar to or coincident with the calculated ratio transition among the results included in the results information. With this configuration, the heater output and the set temperature are acquired so that the surface temperature can be easily estimated.
(5) The estimation unit 17 estimates the surface temperature at the predetermined time from the ratio, which is indicated by the results similar to or coincident with the transition, of the surface temperature to the set temperature at the time corresponding to the predetermined time. With this configuration, the surface temperature is estimated based on the previous results, and therefore, the accuracy of the estimated surface temperature can be improved.
(6) The energy quantity calculation unit 22 calculates the energy quantity by using the parameter calculated from the surface temperature as part of the characteristic information. With this configuration, the estimated surface temperature is used so that the accuracy of the calculated energy quantity can be further improved.

Each preferred embodiments of the controller and program for the injection molding machine according to the present disclosure has been described above, but the present disclosure is not limited to the above-described embodiments and can be modified as necessary. For example, in the above-described embodiments, the results information acquisition unit 14 may acquire the results information on plural points on the surface of one heater 102. With this configuration, the estimation unit 17 may estimate surface temperatures at the plural points on the surface of one heater 102. The energy quantity calculation unit 22 may calculate heat dissipation quantities at the plural points on the surface of one heater 102. In this case, the energy quantity calculation unit 22 may calculate Equation 5 below, assuming that the surface temperature (K) of the heater 102 at each measurement point is T_{Hm}, the area (m²) of each measurement point on the surface of the heater 102 is Aᵢₘ, and a number indicating each measurement point is m=1, 2, . . . . In this manner, the energy quantity calculation unit 22 may obtain the convection heat dissipation quantity E_{Ci} and the radiation heat dissipation quantity E_{Ri}, thereby calculating the heat dissipation quantity.

$${E}_{Ci} = {\sum }_{m} [ {A}_{im} \times {\int }_{{t}_{0}}^{{t}_{1}} \{ ( {T}_{Hm} - {T}_{R} ) \times h \} dt ] \qquad [ Equation 5 ]$$

$${E}_{Ri} = {\sum }_{m} [ {A}_{im} \times {\int }_{{t}_{0}}^{{t}_{1}} \{ ( {T}_{Hm}^{4} - {T}_{R}^{4} ) \times ε \times σ \} dt ]$$

The energy quantity calculation unit 22 may calculate Equation 6 below to calculate the convection heat dissipation quantity E_{Ci}′ and the radiation heat dissipation quantity E_{Ri}′ for the plural measurement points.

$${E}_{Ci}^{′} = {\sum }_{m} [ {A}_{im} \times {\int }_{{t}_{0}}^{{t}_{1}} \{ ( {T}_{Hm} - {T}_{R} ) \times h \} dt ] + {E}_{CNi} ) \qquad [ Equation 6 ]$$

$${E}_{Ri}^{′} = {\sum }_{m} [ {A}_{im} \times {\int }_{{t}_{0}}^{{t}_{1}} \{ ( {T}_{Hm}^{4} - {T}_{R}^{4} ) \times ε \times σ \} dt ] + {E}_{RNi}$$

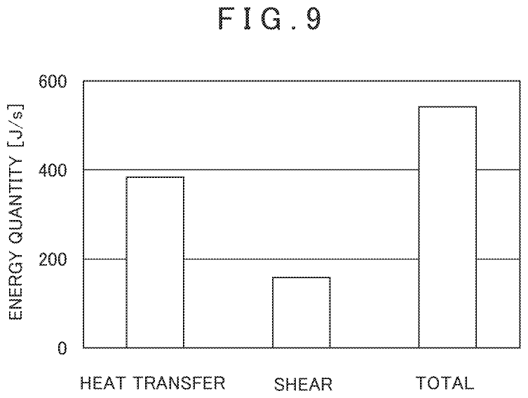

In the above-described embodiments, the output control unit 19 may cause the output unit 18 to display the heat transfer energy quantity, the shear energy quantity and the total by a bar graph as shown in FIG. 9. With this configuration, an energy quantity status can be easily grasped.

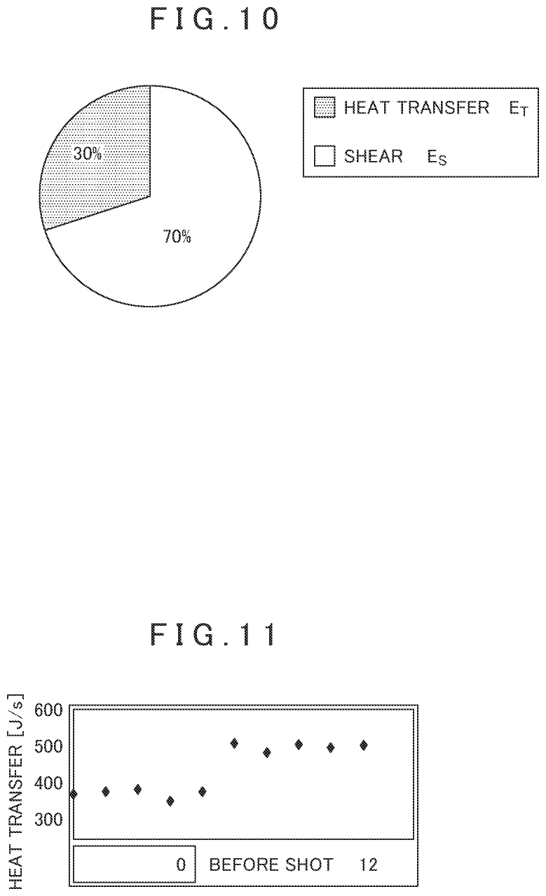

In the above-described embodiments, the output control unit 19 may cause the output unit 18 to display the energy quantity ratios as a pie chart as shown in FIG. 10. With this configuration, the energy quantity ratios can also be easily grasped.

In the above-described embodiments, the output control unit 19 may cause the output unit 18 to display a scatter plot showing the energy quantity according to the predetermined time, as shown in FIG. 11. With this configuration, the energy quantity can be displayed in chronological order, and therefore, an abnormal energy quantity can be easily monitored.

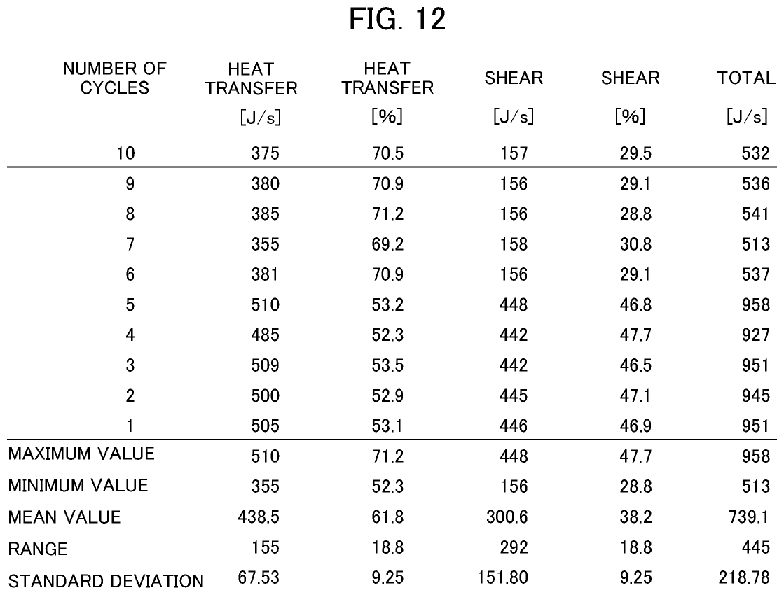

In the above-described embodiments, the output control unit 19 may cause the output unit 18 to display the list of the heat transfer energy quantity, the shear energy quantity, the ratios, and the total energy quantity according to the predetermined time, as shown in FIG. 12. For example, the output control unit 19 may cause the output unit 18 to display, for each item, a maximum value, a minimum value, an average value, a difference between the maximum value and the minimum value, and a standard deviation.

In the above-described embodiments, the results information acquisition unit 14 acquires the results information, and thereafter, the operation information acquisition unit 12 acquires the operation information. However, the present disclosure is not limited to above. The operation information acquisition unit 12 may acquire the operation information before the results information acquisition unit 14 acquires the results information.

In the above-described embodiments, the injection molding machine 10 may be of an in-line screw type or a plunger type. In the above-described embodiments, the surface temperature of the heater 102 included in the results information may be one measured by a direct method using the temperature sensor (not shown) or one measured by an indirect method using thermography (a radiation thermometer, not shown).

In the above-described embodiments, the output unit 18 may be provided separately from the controller 1 (the injection molding machine 10). The controller 1 may manage a plurality of injection molding machines 10. In the above-described embodiments, the output control unit 19 may cause the output unit 18 to display the surface temperature of the heater 102 in addition to the heat dissipation quantity.

In the above-described embodiments, the energy quantity calculation unit 22 may perform calculation at an interval of a predetermined time, such as every unit time or every cycle time. In the above-described embodiments, the energy quantity calculation unit 22 may calculate a total energy quantity or an energy quantity per predetermined unit time. The energy quantity calculation unit 22 may calculate an average energy quantity at a certain time interval or an energy quantity at particular timing.

In the above-described embodiments, the heat generation quantity E_{H} of the heater 102 is not limited to one calculated as in Equation 4. The heat generation quantity E_{H} of the heater 102 may be calculated based on a heater power consumption calculated from the value of current flowing in the heater 102 and a resistance value of the heater 102.

In the above-described embodiments, the screw rotation quantity R may be acquired as a set value for the injection molding machine 10. As the screw rotation quantity R, a detection value from a detector (an encoder) included in the motor (not shown) for rotating the screw may be acquired. The behavior of the motor does not always correspond to the rotation number as set. For the motor, rise and fall times are necessary, for example. In the case of high friction with the resin, the rotation number of the screw sometimes does not reach the set rotation number. For these reasons, the detection value is used so that the accuracy of calculation of the energy quantity can be improved.

In the above-described embodiments, the motor workload is calculated as the shear energy E_{S} as in Equation 3, but the present disclosure is not limited to above. The shear energy E_{S} may be calculated using a value obtained by a power meter (not shown) attached to the motor for rotating the screw.

In the above-described embodiments, the shear energy E_{S} may be calculated by a method other than calculation of the motor workload. For example, the shear energy E_{S} may be calculated from a resin temperature increment due to friction heat between the screw and the resin. For example, the shear energy E_{S} may be calculated from the viscosity and strain rate of the resin.

In the above-described embodiments, the surface temperature acquisition unit 15 may acquire the ratio of the surface temperature to the set temperature instead of the surface temperature. In this case, the controller 1 does not necessarily include the calculation unit 16.

### EXPLANATION OF REFERENCE NUMERALS

1 Controller
10 Injection Molding Machine
12 Operation Information Acquisition Unit
14 Results Information Acquisition Unit
16 Calculation Unit
17 Estimation Unit
21 Characteristic Information Acquisition Unit
22 Energy Quantity Calculation Unit
101 Barrel
102 Heater
103 Safety Cover

1. A controller for an injection molding machine including a barrel, a heater arranged around the barrel, and a screw arranged inside the barrel, the controller being configured to calculate an energy quantity transferred from the heater to resin at a predetermined time, the controller comprising:
an operation information acquisition unit that acquires operation information including a heater output of the heater, a set temperature for the heater, and a rotation number of the screw in a predetermined period immediately before the predetermined time;
a characteristic information acquisition unit that acquires characteristic information regarding a heat dissipation characteristic of the heater;
a surface temperature acquisition unit that acquires a surface temperature of the heater in the predetermined period included in the acquired operation information;
a results information acquisition unit that acquires, as results information, results of a transition in a ratio of the surface temperature of the heater to the set temperature for the heater in association with a transition in the heater output of the heater;
an estimation unit that estimates the surface temperature of the heater at the predetermined time based on the operation information, the results information, and the acquired surface temperature; and
an energy quantity calculation unit that calculates, based on the estimated surface temperature, the characteristic information, and the operation information, a heat dissipation quantity from a surface of the heater to atmosphere and calculates at least a heat transfer energy quantity from the heater to the resin and a shear energy quantity from the screw.

2. The controller for the injection molding machine according to claim 1, wherein the energy quantity calculation unit calculates ratios of the heat transfer energy quantity from the heater to the resin and the shear energy quantity from the screw.

3. The controller for the injection molding machine according to claim 1, further comprising:
a calculation unit that calculates, based on the acquired operation information and the acquired surface temperature, the transition in the ratio of the surface temperature to the set temperature in association with the transition in the heater output included in the operation information,
wherein the estimation unit estimates the surface temperature at the predetermined time by means of the operation information and results similar to or coincident with the calculated ratio transition among results included in the results information.

4. The controller for the injection molding machine according to claim 1, wherein
the surface temperature acquisition unit acquires the surface temperature of the heater in a form of the ratio of the surface temperature of the heater to the set temperature for the heater, and
the estimation unit estimates the surface temperature at the predetermined time by means of the operation information and results similar to or coincident with the acquired ratio transition among results included in the results information.

5. The controller for the injection molding machine according to claim 3, wherein the estimation unit estimates the surface temperature at the predetermined time from the ratio, which is indicated by the results similar to or coincident with the transition, of the surface temperature to the set temperature at a time corresponding to the predetermined time.

6. The controller for the injection molding machine according to claim 1, wherein the energy quantity calculation unit calculates the energy quantity by using a parameter calculated from the surface temperature as part of the characteristic information.

7. A non-transitory computer readable medium which non-transitorily stores a program causing a computer to operate as a controller for an injection molding machine including a barrel, a heater arranged around the barrel, and a screw arranged inside the barrel, the controller being configured to calculate an energy quantity transferred from the heater to resin at a predetermined time, the program causing
the computer to function as units comprising
an operation information acquisition unit that acquires operation information including a heater output of the heater, a set temperature for the heater, and a rotation number of the screw in a predetermined period immediately before the predetermined time,
a characteristic information acquisition unit that acquires characteristic information regarding a heat dissipation characteristic of the heater,
a surface temperature acquisition unit that acquires a surface temperature of the heater in the predetermined period included in the acquired operation information,
a results information acquisition unit that acquires, as results information, results of a transition in a ratio of the surface temperature of the heater to the set temperature for the heater in association with a transition in the heater output of the heater,
an estimation unit that estimates the surface temperature of the heater at the predetermined time based on the operation information, the results information, and the acquired surface temperature, and
an energy quantity calculation unit that calculates, based on the estimated surface temperature, the characteristic information, and the operation information, a heat dissipation quantity from a surface of the heater to atmosphere and calculates at least a heat transfer energy quantity from the heater to the resin and a shear energy quantity from the screw.
